(19) United States
(12) Patent Application Publication
(10) Pub. No.: US 2020/0300010 A1
(43) Pub. Date: Sep. 24, 2020

(54) DOOR CHAIN DEVICE

(71) Applicant: P. J. Doherty, Littleborough, Lancashire (GB)

(72) Inventor: P. J. Doherty, Littleborough, Lancashire (GB)

(21) Appl. No.: 16/607,656

(22) PCT Filed: Apr. 24, 2017
(86) PCT No.: PCT/GB2018/051054

§ 371 Date: Oct. 23, 2019

(30) Foreign Application Priority Data
Apr. 24, 2017 (GB) 1706447.8

(51) Int. Cl. E05C 17/36

(52) U.S. Cl. CPC E05C 17/365

(57) ABSTRACT

A door guard plate having a main body, internal of which are located two compression springs. A chain holder comprising a body and a chain arm having a free end for releasably engaging a chain and a body portion is provided. The main body comprises a slot and the body portion of the chain holder body is contained within the main body and the chain arm of the chain holder extends through the slot of the main body to protrude therefrom and slide therein.

### FIELD OF THE INVENTION

The invention relates to a door locking device that restricts the extent to which a door can be opened, with a view to restricting unauthorised entry.

### BACKGROUND TO THE INVENTION

Door locking devices which allow secure limited opening of a door for permitted inspection of a caller, but prevent unwanted entry, are generally referred to as ‘door chains’. These devices usually comprise a short length of chain one end of which is secured to a door frame the other ‘free’ end of the chain is releasably secured to a guard plate fixedly attached to a door associated with the door frame. When the ‘free’ end of the chain engages the guard plate, the door chain allows the door to be opened a small amount to confirm the identity of the caller but prevents unwanted entry, after inspecting the caller, the ‘free’ end of the chain may be disengaged from the door guard plate allowing the door to be opened fully.

There are shortfalls associated with commercially available door chains although they do offer a degree of security, they provide little resistance to a determined intruder relying solely on the integrity of the fixing means which are typically woodscrews. The present invention provides an improved door chain device that will mitigate the above shortfall and will also be suitable for all types and styles of doors, it will be inexpensive to manufacture having few components and will also be aesthetically pleasing to even discerning consumers. Additionally, the chain can become snagged or caught on the housing of the device.

### SUMMARY OF THE INVENTION

According to the present invention is directed to a door guard plate comprising:
a main body, internal of which are located two compression springs; and
a chain holder comprising a body portion and a chain arm extending therefrom and having a free end for releasably engaging a chain and a body portion;
wherein, the main body comprises a slot and the body portion of the chain holder body is contained within the main body and the chain arm of the chain holder extends through the slot of the main body to protrude therefrom and slide therein.

The chain holder body may have two spring engaging limbs that can be arranged adjacent the two compression springs within the main body. This provides a reliable surface against which the springs can provide a biasing force. The main body may be a housing that is provided on the device.

Preferably, the main body comprises an angled face such that the thickness of the main body decreases over the length of the angled face, with the thinner end of the angled face being distal from the free end of the chain arm of the chain holder and, in use, proximal to the door. Having a chamfered, tapered or angled face provides a surface against which the chain can be guided. This reduces the risk of the chain becoming caught or snagged on the main body, which is a problem with known devices where the end surface is not angled.

In one arrangement, the two spring engaging limbs extend are arranged to extend from a central axis and substantially 90 degrees therefrom centrally and they may be arranged adjacent one end of the chain holder.

Advantageously, a first section of the chain arm of the chain holder extends at a 90 degree angle from the body portion of the chain holder and protrudes through the slot in the main body and a second section of the chain arm further extends at another 90 degree angle to form a hook shape, extending away from the angled face of the main body. The hook shape provides a mechanism for engaging a door chain. Clearly, the angles on the chain holder may be varied but still allow the chain holder to form an arm that engages the chain, when in use. For example, the arm may extend a 60 degrees from the chain holder body and then at a further 120 or 130 degrees to form the chain engaging arm. Other angles may be possible that still form the hook shape required to engage the chain.

A base plate may be provided to which the door guard plate may be attached.

In a preferred embodiment, the corners of the main body between the angled face and the side of the main body are arcuate. This reduces the risk of the chain catching on an angled corner of the main body, thereby providing a more reliable device.

A channel may be provided in the outer surface of the main body that extends towards the angled face. This provides a route through which the chain may pass to reduce it snagging or catching and so it provides a path for the chain.

The invention extends to a door chain device comprising a chain and a door guard plate as described herein.

The invention further extends to a system comprising a guard plate as described herein attached to a door and a chain connected to a door frame, wherein an edge of the door guard plate is adjacent the edge of the door and the free end of the chain arm of the door guard plate extends away from the door frame and towards the centre of the door.

Accordingly a door chain device may be provided comprising an anchor plate that is fixedly attached to a door frame for securing one end of the chain to said door frame, a door guard plate fixedly secured to a door operatively associated with the door frame and means provided to releasably secure the ‘free’ end of said chain to the door guard plate. The chain can only be engaged and disengaged from the door guard plate when the door is closed.

The door guard plate may incorporate at least one spring, which can act as a damper to absorb a force or forces applied to a partially opened door, when the door chain device according to the invention, is in use.

Preferably, the dampening means comprises two strong compression springs.

Preferably, the chain comprises a plurality of links with adjacent links being rotationally offset with respect to one another.

The door guard plate may comprise a main body which is in the form of a narrow elongated main body, or housing, which has one side open, said housing defines internally, a pair of spaced spring receiving compartments, a chain holder which is mounted within said housing and between the spring receiving compartments and is biased to a first position by the compression springs, a bent arm of the chain holder extends outward of the housing to be engageable by any available link of the chain, any force applied to the chain will cause the chain holder to move away from its first position against the force of the springs. A back plate is also provided to close the open back side of the housing, said back plate may be secured to the housing with adhesive or by other suitable means. A number of screw fixing apertures are provided in the sides of the housing by means of which the fully assembled door guard plate is secured to a door.

Alternatively, the back plate may be secured to the back face of a door with screws or bolts and the housing, chain holder and spring assembly then mounted on and secured to the back plate with threaded bolts.

The door guard plate is, preferably, fixedly securely to a door, adjacent the door edge and thereby acts to protect the edge of the door from damage by the chain.

The door frame anchor plate may be fixedly secured to a door frame for securing one end of the chain to said frame, alternatively the chain may be connected directly to the door frame.

### BRIEF DESCRIPTION OF THE DRAWINGS

Embodiments of the present invention will now be described further by way of example, with reference to the accompanying drawings, in which:

FIG. 1 is a front view of a door chain device in accordance with the present invention, secured to a door and door frame and in its operative position;

FIG. 2 is a view of the front elevation of the guard plate housing of FIG. 1;

FIG. 3 is a back view of the rear elevation of the guard plate housing of FIG. 1;

FIG. 4 is a perspective view of the chain holder of FIG. 1;

FIG. 5 is a side view of the chain holder of FIG. 4;

FIG. 6 is a front view of the chain holder of FIG. 4;

FIG. 7 is a perspective view of the back plate of FIG. 1;

FIG. 8 is a part cross sectional view of the guard plate housing of FIG. 1;

FIG. 9 is a part cross sectional view of a partially assembled door guard plate of FIG. 1 along line A-A;

FIG. 10 is an underside view of the guard plate housing of FIG. 1 with back plate assembled thereon.

FIG. 11 is a view of the front end of the assembled door guard plate of FIG. 1;

FIG. 12 is a view of the back end of the assembled door guard plate of FIG. 1;

FIG. 13 is a cross sectional view of the guard plate housing of FIG. 1 along line C-C;

FIG. 14 is a cross sectional view of the guard plate housing of FIG. 1 along line B-B;

FIG. 15 is a cross sectional view of the housing of FIG. 1 along line C-C with chain holder assembled therein;

FIG. 16 is a perspective view of the components of the door frame anchor bracket;

FIG. 17 is a part cross sectional view of a partially assembled door guard plate according to a second example of the invention;

FIG. 18 is a perspective view of a modified back plate for the housing of FIG. 17;

FIG. 19 is a perspective view of a door guard plate in accordance with a third embodiment of the present invention;

FIG. 20 is an underside view of the assembled door guard plate of FIG. 19;

FIG. 21 is a perspective view of an alternative chain holder for the door guard plate of FIGS. 19 to 22; and

FIG. 22 is a part cross sectional view of the partially assembled door guard plate of FIGS. 19 to 22.

Where possible, the same numerals have been used throughout this specification to denote similar components.

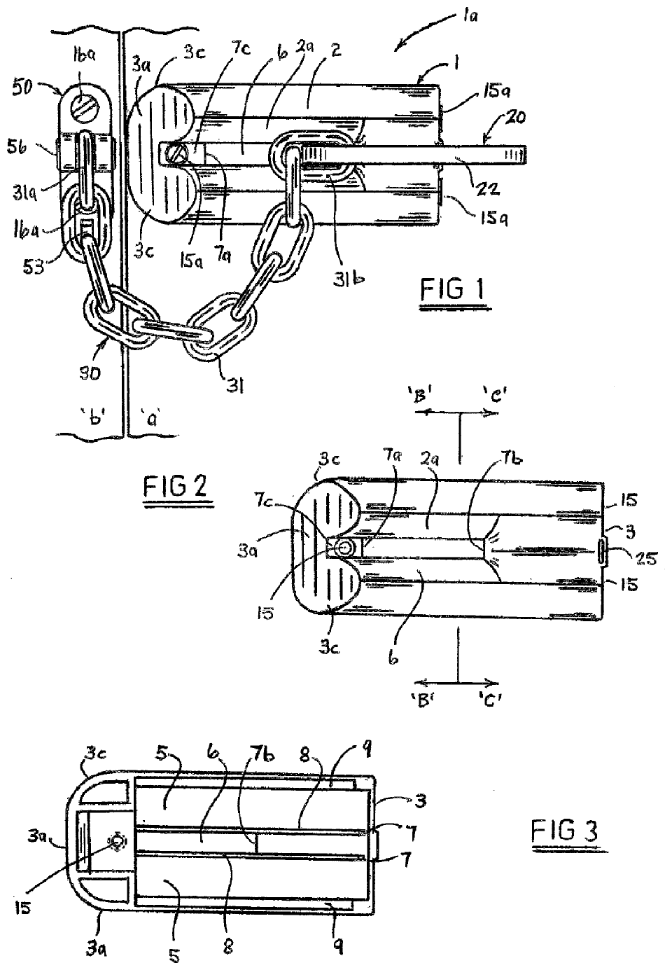

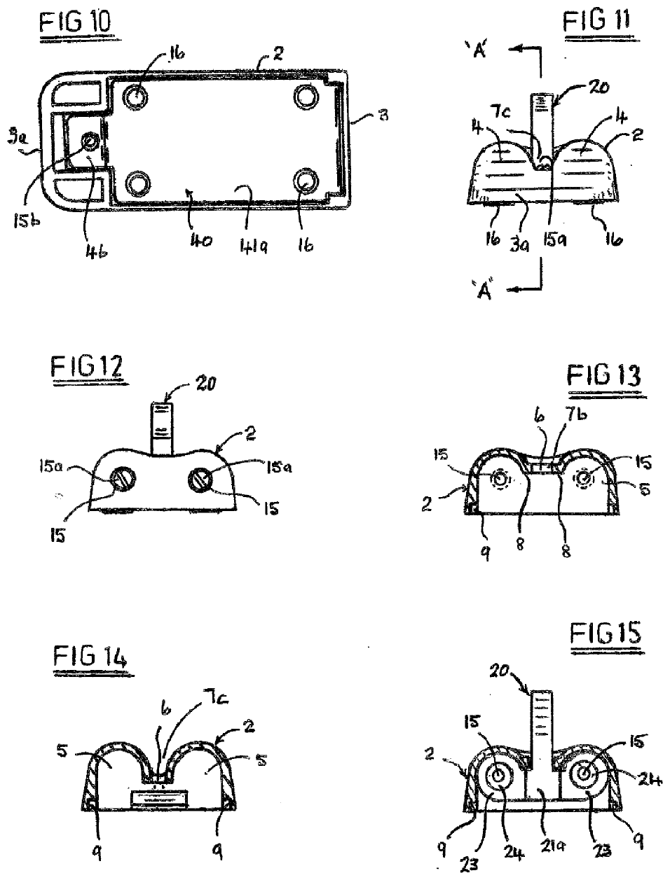

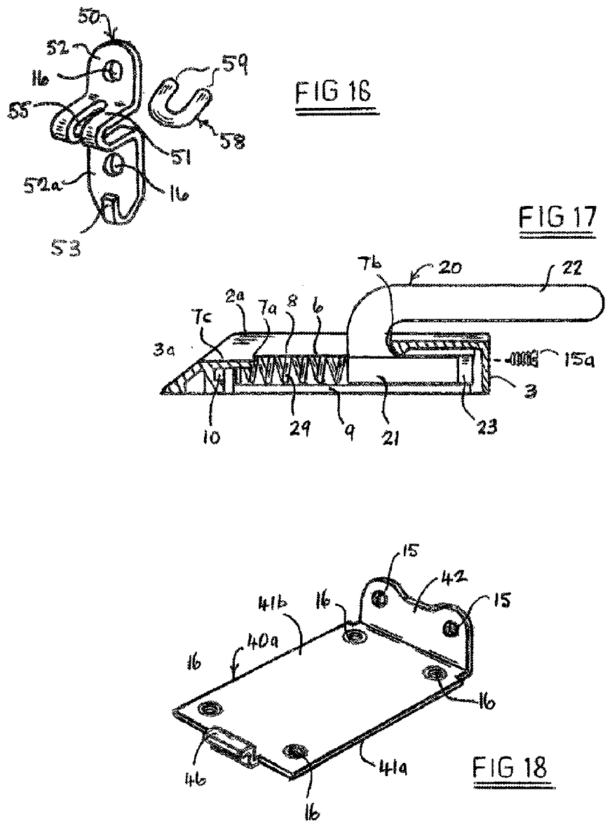

Reference is now made to FIGS. 1 to 16, which show the first example of a door chain device according to the present invention. The illustration of FIG. 1 shows the complete assembly 1a fixedly secured to a door ‘a’ and door frame ‘b’, with the door chain device in its operative or standby condition, one end of the chain 30 is secured in the door frame anchor plate 50 that is fixedly secured to the door frame ‘b’ the other, free end of the chain 30 is releasably secured to the guard plate 1, by means of the chain link 31b which is engaged on the arm 22 of the chain holder 20. The door guard plate 1 is secured to the inner surface of a door ‘a’, at the very edge of the opening side of the door ‘a’ and will therefor protect the door ‘a’ from damage by the chain 30.

The door chain device 1a comprises a door guard plate 1, a door frame anchor bracket 50 and a short length of chain 30.

The door guard plate 1 comprises a metal housing 2, a chain holder 20, two compression springs 29 and a base/mounting plate 40.

The housing 2 is preferably formed as a metal die casting, metal pressing or fabricated from a suitable plastic material and is in the form of a generally elongate or rectangular enclosure with an open back, the inside of the housing 2 is partitioned longitudinally to provide two spaced spring receiving compartments 5, a long narrow aperture 6 is defined centrally and longitudinally in the front face 2a of the housing 2 in the space between the spring receiving compartments 5 said aperture 6 is to allow passage of the arm 22 of the chain holder 20, and facilitates transverse movement of the chain holder 20 in the housing 2. Two spaced screw receiving apertures 15 are provided in the back side 3 of the housing 2 by means of which said back end 3 is secured to the base plate 40 with screws 15a, a further screw receiving aperture 15 is provided centrally and close to the front end of the housing 2 in the chain location recess 7c, by means of which the front end of said housing 2 is secured to the base plate 40 with screws 15a. The front end 3a of the housing 2 defines an angled face, the angle of said face is preferably no less than 50 degrees with large radiuses 3c on the front corners which are fashioned to blend with the angled face of the front end 3a of the housing 2.

A gap 7 is provided between the ends of the partition walls 8 respectively and the back wall 3 of the housing 2 said gap 7 is to accommodate the wall 42 of the base plate 40.

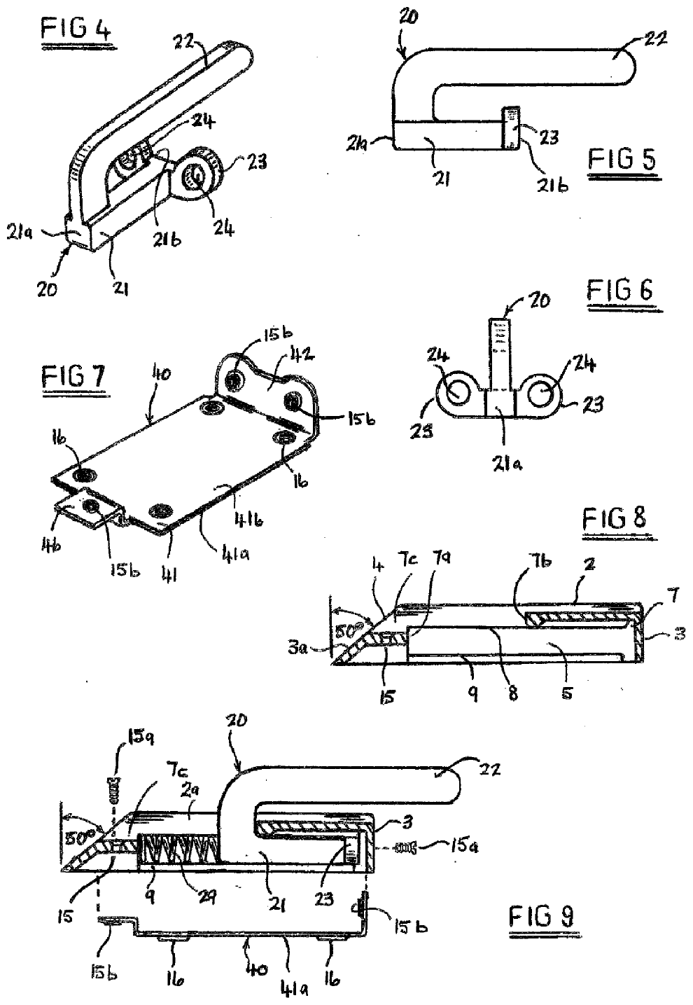

A chain holder 20, as shown in FIGS. 4 to 6, locates in the housing 2 and is positioned between the two compression springs 29 said chain holder 20 is preferably formed as a metal die casting or may be steel and defines a flat rectangular body portion 21 from which a chain receiving arm 22 extends at 90 degrees centrally and adjacent the front end 21a, said chain receiving arm 22 is bent at 90 degrees to provide a radius of approximately 6 mm and to be parallel with the body 21 of the chain holder 20, the chain receiving arm 22 extending approximately 30 mm past the back end 3 of the door guard plate 1. The chain holder 20 also defines a pair of spring engaging limbs 23 which extend outwards at 90 degrees respectively from the back end 21b of the body 21 said limbs 23 are fashioned and dimensioned to be a clearance or snug fit in the spring receiving compartments 5 to engage respectively one end of each spring 29, said limbs 23, in use, act to compress the springs 29 when force is applied to the spring holder 20 by the chain 30.

An aperture 24 is provided centrally in each of the spring engaging limbs 23 said apertures 24 to allow passage of the screws 15a used to secure the back end of the housing 2 to the base plate 40. The chain receiving arm 22 extends through the elongated slot 6 in the front face of the housing 2 to be accessible to the chain link 31b or any available link, said elongated slot 6 guides, supports and limits the transverse movement of the chain holder 20 in the housing 2. The chain holder 20 is slidably mounted in the housing 2 between the base plate 40 and the inner dividing walls 8 of the spring receiving compartments 5, FIG. 9 best illustrates the position of the chain holder 20 in its first inoperative position in which position, the springs 29 respectively, are pre-loaded against the limbs 23 of the chain holder 20 and acting to bias said chain holder 20 against the stop face 7b at the back end of the elongated slot 6.

The base plate 40 is generally a flat, rectangular strip of metal plate with a first end portion bent at 90 degrees to form a wall 42, the main body 41 of the base plate 40 is provided with spaced screw receiving apertures 16 to receive woodscrews 16a (not shown) by means of which it is secured to the inside face of the door ‘a’, a pair of spaced threaded apertures 15 are provided in the back wall 42 of the base plate 40 by means of which the back end of the housing 2 is secured to the wall 42 of the base plate 40 with screws 15a. A hook formation 46 depends centrally from the front or second end portion of the base plate 40 said hook 46 is provided with a threaded aperture 15 by means of which the front end of the housing 2 is secured to the base plate 40 with screws 15a. The base plate 40 locates on the shoulder 9 in the housing wall 2 and the outer surface 41a of the base plate 40 will be flush with the back surface of the housing 2, the base plate 40 also acts to protect the surface of the door ‘a’ and provide a low friction metal to metal sliding surface for the chain holder 20.

The chain 30 comprises a plurality of links with adjacent links being rotationally offset with respect to one another, preferably, the links 31 are stainless steel and short links fabricated from standard 4 mm wire. Preferably, the end link 31b on the free end of the chain 30 is releasably engaged on the arm 22 of the chain holder 20 as shown in FIG. 1, alternatively, a ring 36 (not illustrated), may be secured to the free end of the chain 30 for engagement of the arm 22, alternatively, a number of chain links 31 on the free end of the chain 30 may be made available for engagement on the arm 22 of the chain holder 20.

The door frame anchor bracket 50, comprises a generally U shaped body 51 with a pair of attachment flanges 52 and 52a, said flanges define respectively, a screw fixing aperture 16, the bottom flange 52a is longer and its end is fashioned and bent at 180 degrees to form a hook 53 on which to hang the link 31b when the door chain device 1a is not in use. A deep through slot 55 is provided centrally in the U-shaped body 51 of the bracket 50 to receive the link 31a on the end of the chain 30. In order to secure one end of the chain 30 to the anchor bracket 50 the link 31a is first inserted into the slot 55 until the link 31a abuts the flanges 52 and 52a, a half link 58 is then engaged in the link 31a via the back of the bracket 50 to secure the chain 30 to the bracket 50. When the anchor bracket 50 is fixedly secured to a door frame ‘b’ with screws 15 the ends 59 of the half link 58 will be abutting the door frame ‘b’ effectively locking the half link 58 against removal, alternatively, as illustrated in FIG. 1 a headed locking rivet 56 may be used to secure the chain 30 to the anchor bracket 50, the non-headed end of the rivet 56 being peened over to retain said rivet captive in the bracket 50.

In the UK in excess of 80 percent of external doors are panelled, the maximum width of styles, that is, the distance between the opening edge of the door ‘a’ and raised panelling, on these types of doors is 100 mm, this requires that the door guard plate 1 is fixed adjacent the opening edge of a door ‘a’, there is not room to place a slide plate in front of the door guard plate 1 in order to protect the door ‘a’ from the chain 30, as is proposed in prior art U.S. Pat. No. 4,648,642, also, the prior art device as illustrated and described is clearly intended and required to be set back from the door edge as it would not function or act as a damper if it was fixed adjacent the edge of a door ‘a’, furthermore, the chain 30 will abut and jam against the lower front corner of the housing of the device when the door ‘a’ is opened to inspect a caller due to the fact that the front end of the housing is not substantially angled and the front sides contoured.

For a door chain to receive broad market appeal and not be excluded from a large segment of the market it must be suitable for panelled doors and the door guard plate 1 should preferably be no longer than 95 mm, any longer and it may be encroaching onto or over door panelling, it is for this reason the door guard plate 1 of the present invention has been designed to be able to be secured at the very edge of the door ‘a’, and at the height conventional door chains are normally fixed.

Due to the above mentioned restraints, the chain holder 20 of the invention is positioned toward the back end 3 of the housing 2 and the forward travel of said chain holder 20 is restricted by the end wall 7a of the slot 7 and it is unlikely that the chain holder 20 would abut the end 7a of the slot 7 even in a severe attempted forced entry, the chain holder 20 would remain a chain link distance from the door edge ensuring that the door chain device 1a would always function effectively. The door chain device 1a would not function as intended if the chain holder arm 22 or any part of the chain holder 20 in its operation was allowed to project past the edge of the door ‘a’

Testing has established that the front end 3a of the housing 2 is required to be angled at preferably a minimum of 50 degrees with large radiuses 3c at the sides, this ensures that the chain 30 will transition smoothly across the front 3a of the housing 2 to locate in the central channel 7c, when the door ‘a’ is opened ‘on chain’ for inspection of a caller. Without such a steep angled/contoured front end 3a the chain 30 will abut and jam against the lower front corner of the housing 2, which, in an extreme situation could cause the door guard plate 1 to become dislodged compromising the door chain 1a and security.

The housing 2 is mounted on and secured to the base plate 40, said base plate 40 protects the surface of the door ‘a’ from scaring by the chain holder 20 and provides a smooth sliding surface (metal to metal) for the chain holder 20. The base plate 40 is secured to the door ‘a’ with suitable screws or suitable threaded bolts if being fixed to plastics material doors, such as unplasticized polyvinyl chloride (uPVC).

To assemble the door guard plate 1, enter the chain holder 20 into the housing 2 through its open back side, passing the arm 22 of the chain holder 20 through the aperture 6 and move said chain holder 20 toward the back of the housing 2 until it abuts the end 7b of the slot 6, insert the springs 29 into their respective compartments 5, this requires the springs 29 to be compressed against the inside surface of the front wall 3a while simultaneously forcing the free end of said springs respectively into engagement with the limbs 23 of the chain holder 20. Once thus assembled, the slightly loaded springs 29 will retain said assembly together until it is required to be mounted on and secured to the base plate 40 with screws 15a.

When the door chain device 1a is fixedly secured to a door ‘a’ and door frame ‘b’ (FIG. 1), and the device is not operational, the link 31b on the free end of the chain 30 is engaged on the hook 53 of the anchor bracket 50.

To place the door chain device 1a on standby or in its operational condition the chain 30 is disengaged from the hook 53 of the anchor bracket 50 and the end link 31b, or any other available link 31, is engaged on the arm 22 of the chain holder 20 when the components of the door chain device 1a will assume the position illustrated in FIG. 1. When a caller comes to the door ‘a’, the door ‘a’ may be opened a distance determined by the length of the chain 30, a door movement of approximately 10 cm, sufficient to allow a caller to be identified.

The chain 30 is of a length that will comfortably allow the link 31b to be engaged on the arm 22 of the chain holder 20 but requires that the door ‘a’ must be closed in order to disengage the chain 30 from the door guard plate 1. With the door chain device 1a operational and when the door ‘a’ is opened for inspection of a caller, any attempt at forced entry will cause the chain 30 to pull on the chain holder 20 against the force of the compression springs 29 said chain holder 20 being moved transversely in the aperture 6 in the housing 2, simultaneously, the springs 29 will absorb and mitigate the applied force. Strain on all the screw fixings is dramatically reduced by the use of the damper springs 29 said springs 29 are fully supported in the housing 2 by their individual enclosures and the base plate 40.

Referring now to FIGS. 17 and 18 which illustrate an alternative method of securing the housing 2a to the base plate 40a all other aspects are the same as the previous embodiment.

The housing 2a in this example is provided with an elongated bore 10 centrally and internally in the housing 2a said bore 10 is to receive and locate the hook formation 46 defined centrally at the front end of the base plate 40a, this arrangement eliminates the need for a screw fixing in the central channel 7c at the front of the housing 2a.

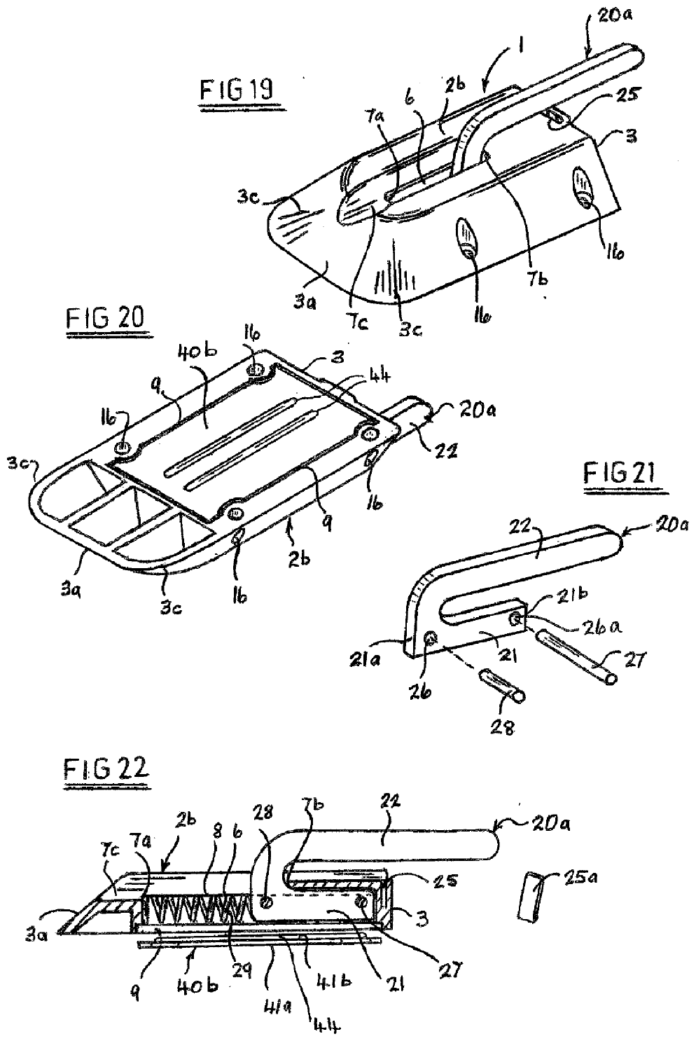

Referring now to FIGS. 19 to 22 which illustrate an alternative or modified door guard plate 1. In this example the guard plate 1 is secured to the inner surface of the door ‘a’ with suitable wood screws or threaded bolts (not shown) by means of screw receiving apertures 16 provided in the sides of the housing 2b.

The base plate 40b is generally a thin metal plate, a pair of spaced ribs 44 are defined centrally and depend from the inner surface 41b of the base plate 40b said raised ribs 44 act as additional transverse guides and support for the chain holder 20a. The base plate 40b locates on the step 9 in the housing 2b when its outer side 41a will be flush with the back face of the housing 2b. The base plate 40b may be secured to the housing 2b with adhesive or other suitable means.

The chain holder 20a in this example is preferably produced as a pressing or stamping from a 4 mm thick sheet of stainless steel. The body 21 of the chain holder 20a is provided with a pair of spaced apertures 26 and 26a respectively, one at each end thereof said apertures to receive hardened steel pins, or alternatively roll pins, which, in use, act as runners (FIG. 22) to bear against the partition wall 8 in the housing 2b to retain the chain holder 20a in the housing 2b. The short pin 28 locates in the front aperture 26 in the body 21, when the pin 28 is in position it protrudes from each side of the body 21 in order to abut against the partition walls 8, the pin 28 locks the front end 21a of the chain holder 20a in the housing 2b.

The longer pin 27 locates in the rear aperture 26a of the body 21, when the rear pin 27 is in position it protrudes from each side of the chain holder body 21 sufficient to allow it to engage fully the back end of the compression springs 29 said pin 27 bears against the partition walls 8 and locks the back end 21b of the chain holder 20a in the housing 2b. In use, the springs 29 respectively, are lightly loaded against the long pin 27, transverse movement of the chain holder 20a in the housing 2b will cause the pin 27 to compress the springs 29 and provide the damper means. The back end 21b of the chain holder body is spring biased against the inner surface of the back wall 3 of the housing 2b. The chain holder 20a of this embodiment may be used as an alternative in the housing 2 and 2a.

A narrow slot or bore 25 is provided centrally in the front surface of the housing 2b in the back wall 3 said slot 25 is to receive a short rectangular strip of plastic 25a which is thin and very flexible. When the plastic strip 25a is fully engaged in the slot 25 it protrudes therefrom approximately 4 mm in order to be engageable by the chain link 31b as said link 31b is being engaged on or removed from the chain holder arm 22. A small force is required to bend the plastic strip 25a to allow passage of the link 31b. The plastic strip 25a will prevent inadvertent removal of the chain 30 from the chain holder 20 and 20a.

All other aspects of this example are similar to that of FIGS. 1 to 16.

1: A door guard plate comprising:
a main body, internal of which are located two compression springs; and
a chain holder comprising a body portion and a chain arm extending therefrom and having a free end for releasably engaging a chain and a body portion;
wherein the main body including a slot and the body portion of the chain holder is contained within the main body and adjacent the two compression springs and the chain arm of the chain holder extends through the slot of the main body to protrude therefrom and slide therein, and
wherein one end of the main body including an angled face such that the thickness of the main body decreases over the length of the angled face, with a thinner end of the angled face being distal from a free end of the chain arm of the chain holder and, in use, proximal to a door.

2: The door guard plate according to claim 1, wherein the body portion of the chain holder comprises two spring engaging limbs.

3: The door guard plate according to claim 2, wherein the two spring engaging limbs extend from a central axis of the chain holder and substantially at 90 degrees to the central axis of the chain holder.

4: The door guard plate according to claim 1, wherein a first section of the chain arm of the chain holder extends at a 90 degree angle from the body portion of the chain holder and a second section of the chain arm further extends at another 90 degree angle from the first section to form a hook shape.

5: The door guard plate according to claim 1, wherein the door guard plate further comprises a base plate.

6: The door guard plate according to claim 1, wherein corners of the main body between the angled face and a side of the main body are arcuate.

7: The door guard plate according to claim 1, wherein a channel is defined in an outer surface of the main body that extends towards the angled face.

8: A door chain device comprising a chain and the door guard plate according to claim 1.

9. (canceled)

10: A system comprising:
a door guard plate attachable to a door, the door guard plate comprising:
a main body, internal of which are located two compression springs; and
a chain holder comprising a body portion and a chain arm extending therefrom and having a free end for releasably engaging a chain and a body portion;
wherein the main body including a slot and the body portion of the chain holder is contained within the main body and adjacent the two compression springs and the chain arm of the chain holder extends through the slot of the main body to protrude therefrom and slide therein, and
wherein one end of the main body including an angled face such that the thickness of the main body decreases over the length of the angled face, with a thinner end of the angled face being distal from a free end of the chain arm of the chain holder and, in use, proximal to the door; and
a chain connected to a door frame;
wherein an edge of the door guard plate is adjacent the edge of the door and the free end of the chain arm of the door guard plate extends away from the door frame and towards a center of the door.

11: The system according to claim 10, wherein the body portion of the chain holder comprises two spring engaging limbs.

12: The system according to claim 11, wherein the two spring engaging limbs extend from a central axis of the chain holder and substantially at 90 degrees to the central axis of the chain holder.

13: The system according to claim 10, wherein a first section of the chain arm of the chain holder extends at a 90 degree angle from the body portion of the chain holder and a second section of the chain arm further extends at another 90 degree angle from the first section to form a hook shape.

14: The system according to claim 10, wherein the door guard plate further comprises a base plate.

15: The system according to claim 10, wherein corners of the main body between the angled face and a side of the main body are arcuate.

16: The system according to claim 10, wherein a channel is defined in an outer surface of the main body that extends towards the angled face.

17: The system according to claim 10, wherein the chain includes at least one loop that receives the free end of the chain arm.
